(19) United States
(12) Patent Application Publication
(10) Pub. No.: US 2026/0079171 A1
(43) Pub. Date: Mar. 19, 2026

(54) OPERATIONAL CONTROL OF ACTUATOR(S) IN A TEST MACHINE

(71) Applicant: ILLINOIS TOOL WORKS INC., Glenview, IL (US)

(72) Inventors: Jeffrey Richard Estum, Eden Prairie, MN (US); Michael Paul Arens, Greenfield, MN (US)

(21) Appl. No.: 19/319,218

(22) Filed: Sep. 4, 2025

Related U.S. Application Data
(60) Provisional application No. 63/696,145, filed on Sep. 18, 2024.

(51) Int. Cl. G01N 35/00; G01N 3/36

(52) U.S. Cl. CPC G01N 35/0092; G01N 3/36; G01N 2035/0094; G01N 2035/0097

(57) ABSTRACT

A method of optimizing a test profile for testing an item includes performing a test iteration by changing a sensor-detectable condition of the item using actuator(s) according to an iteration of the test profile, measuring an actual sensor-detectable condition during the test iteration, identifying a first segment of the test profile specifying a first segment transition in which dynamic null pacing occurred when executing the first segment during the test iteration, measuring a first duration that is an actual length of a segment transition for the channel during the test iteration corresponding to a specified segment transition of the first segment, increasing a length of the first segment to be equal to the first duration in a first adjusted iteration of the test profile, and performing another test iteration by changing the sensor-detectable condition of the item using the actuator(s) according to the first adjusted iteration of the test profile.

### CROSS-REFERENCE TO RELATED APPLICATION(S)

The present application is based on and claims the benefit of U.S. provisional patent application Ser. No. 63/696,145, filed Sep. 18, 2024, the content of which is hereby incorporated by reference in its entirety.

### FIELD

The present invention relates to systems and methods for controlling actuators in a test machine or device and, more specifically, to systems and methods for operational control of the test machine or device allowing for improved test profile optimization.

### BACKGROUND

Testing is often performed to evaluate materials and items. For example, items can be arranged in a test device (or test machine) that includes one or more actuator(s) configured to selectively change a sensor-detectable condition of the item under testing (e.g., by selectively applying loads to that item) along with sensor(s) to measure testing-related data associated with the item. The number of actuators for a given test can vary, but some tests can involve hundreds of discrete actuators arranged in an array that apply loads to different portions of the item. A given test profile using the test device can include executable instructions or protocols for how each of the actuators should be actuated to change a sensor-detectable condition of the item (e.g., how a load-applying actuator should apply load(s) to the item) over time. A profile can, for instance, be expressed in the form of a table with rows denoting a channel that indicates actuator-applied conditions over time for one or more of the actuators that are commonly commanded to apply specified changes in a sensor-detectable condition of the item. The time between any two adjacent actuator-applied conditions in a profile is referred to as a segment. Each segment can encompass one or more discrete channels, each controlling one or more actuators.

A profile for a given test is established by a user of the test device, and may be custom-developed for each desired test. In this sense, a test and associate profile can be bespoke setups rather than standardized, which can leave uncertainty about how actual test conditions will unfold. But users are often making merely an educated guess at the length of time a given segment transition will actually take to transition the sensor-detectable changes applied by a given channel from a starting condition to an ending condition when a test is executed.

If, upon commencing a test, a difference between an actual and commanded sensor-detectable condition of a given channel in a given segment is too great (that is, outside a specified allowable error margin), the test device can automatically slow the rate of change of the actuator(s) of that segment by applying dynamic null pacing. In this way, dynamic null pacing interrupts test progress to help ensure valid and/or reliable test data is collected across all channels, but at the cost of slowing overall test progress and increasing the time to complete an iteration, pass, or cycle of a complete profile. The application of dynamic null pacing can result, for instance, from a user setting up an initial profile without knowing precisely how long it will take actuators to apply desired loading in a given segment, and/or the result of one or more actuators in a given channel operating differently than desired or expected. Dynamic null pacing (which can also be referred to simply as null pacing) can be implemented as part of a proportional integral derivative (PID) control loop mechanism, for instance.

Testing profiles with many segments may take a long time to execute, with that time enlarged by the occurrence of null pacing. And, additionally, the time to set up a test by placing an item in the test device and arranging or otherwise configuring all actuators and sensors to apply sensor-detectable changes to the item at desired locations and measure test data can involve considerable effort over a significant length of time.

Testing is often performed iteratively, with modifications made to the test profile along the way, but often leaving the physical test setup substantially unchanged. In subsequent test iterations, a given profile can be adjusted to promote optimization. Establishing an optimized profile with the shortest overall length without null pacing on any profile segments is particularly useful for fatigue or durability tests, for example. Known testing devices can allow the user to specify increments, such as a percentage of segment length (i.e., transition time), to adjust segment lengths in a profile in subsequent testing iterations. In known implementations, the test device can then automatically reduce the length (i.e., transition time) of each segment by the user-specified percentage until null pacing occurs on a given channel, then, in subsequent test iterations, increase the length of segment(s) in which null pacing occurred by the user-specified percentage until no null pacing occurs. After a sufficient number of test iterations, an optimized profile can be established that provides for the relative minimum overall profile length without null pacing on any segments.

However, the number of test iterations needed for a profile to converge to an optimal profile can be large, encompassing many dozen or even nearly a hundred (or more) iterations. In this sense, profiles can be optimized by prior art test devices but it can take a considerable amount of time to complete the number of test iterations needed to arrive at optimized segment lengths that avoid null pacing through essentially only a guess-and-check approach.

### SUMMARY

In one aspect, a method of optimizing a test profile for testing an item to be tested can include performing a test iteration by changing a sensor-detectable condition of the item to be tested using one or more actuators according to an iteration of the test profile, measuring an actual sensor-detectable condition during the test iteration, identifying a first segment of the test profile specifying a first segment transition for a channel encompassing one or more of the one or more actuators in which dynamic null pacing occurred when executing the first segment during the test iteration; measuring a first duration during the test iteration (in which the first duration is an actual length of a segment transition for the channel during the test iteration corresponding to a specified segment transition of the first segment), increasing a length of the first segment to be equal to the first duration in a first adjusted iteration of the test profile, and performing another test iteration by changing the sensor-detectable condition of the item to be tested using the one or more actuators according to the first adjusted iteration of the test profile.

The method may include any of the following features. A second segment of the test profile can be identified by specifying a second segment transition for at least one of the one or more actuators in which dynamic null pacing did not occur when executing the second segment during the test iteration, and decreasing a length of the second segment. The step of identifying the second segment in which dynamic null pacing did not occur can be performed concurrently with the step of identifying the first segment of the test profile in which dynamic null pacing occurred.

The method can include: performing a prior test iteration by changing the sensor-detectable condition of the item to be tested using the one or more actuators according to a prior iteration of the test profile, wherein the test iteration occurs after the prior test iteration; determining that dynamic null pacing did not occur when executing the first segment during the prior test iteration; and decreasing a length of the first segment, such that the length of the first segment in the iteration of the test profile is shorter than the length of the first segment in the prior iteration of the test profile.

The step of measuring the actual sensor-detectable condition during the test iteration can involve sensing loading in a load path between at least one of the one or more actuators and the item to be tested.

The test profile can be further adjusted as the item to be tested undergoes physical changes over a plurality of test iterations. The actual sensor-detectable condition can be selected from the group may include of load, velocity, acceleration, pressure, displacement, temperature, electrical resistivity, position, angle, and rotations per minute (rpm).

In another aspect, a method of testing an item with a test device can include establishing an initial iteration of a test profile with a plurality of segments each specifying a load transition, performing an initial test iteration by applying loads to the item using a plurality of actuators according to the initial iteration of the test profile, measuring actual loading during the initial test iteration, identifying dynamic null pacing during at least the initial test iteration; measuring a first duration (in which the first duration is an actual length of a load transition during the initial test iteration corresponding to a specified load transition of the initial iteration of the test profile), iteratively shortening a length of at least one of the segments of the test profile in which null pacing has not yet occurred during any prior test iteration including during the initial test iteration, increasing a length of at the least one of the segments of the test profile based on analysis of the identified dynamic null pacing such that the length of the at least one segments of the test profile is equal to the first duration in an adjusted iteration of the test profile, and performing another test iteration by applying loads to the item using the plurality of actuators according to the adjusted iteration of the test profile.

The method may include any of the following features. The step of increasing the length of the at least one segment of the segments of the test profile based on analysis of the identified dynamic null pacing can increase the length of at least one of the segments that was previously shortened during the step of iteratively shortening the length of at least one of the segments of the test profile in which null pacing has not yet occurred during any prior test iteration including during the initial test iteration.

The step of increasing the length of at least one segment of the test profile based on analysis of the identified dynamic null pacing can be performed concurrently with the step of iteratively shortening the length of at least one of the segments of the test profile in which null pacing has not yet occurred during any prior test iteration including during the initial test iteration.

The step of measuring actual loading during the initial test iteration can involve sensing loading in a load path between the plurality of actuators and the item.

In yet another aspect, a test device for testing an item can include one or more actuators, one or more sensors, one or more controllers operatively connected to the one or more actuators and the one or more sensors, and machine-readable instructions stored in at least one non-transitory storage medium. The machine-readable instructions are executable by any number of the one or more controllers to execute the steps of performing a first test iteration by changing a sensor-detectable condition of the item using the one or more actuators according to a first iteration of a test profile, measuring an actual sensor-detectable condition during the first test iteration using the one or more sensors, identifying dynamic null pacing during at least the first test iteration using at least one of the one or more controllers, measuring a first duration (in which the first duration is an actual length of a segment transition during the first test iteration corresponding to a specified sensor-detectable condition transition of the first iteration of the test profile), and increasing a length of at least one segment of the test profile based on analysis of the identified dynamic null pacing such that the length of the at least one segment of the test profile is equal to the first duration in an adjusted iteration of the test profile.

The test device may include any of the following features. The test device can have machine-readable instructions that are further configured to execute the step of: iteratively shortening a length of at least one of the segments of the test profile in which null pacing has not yet occurred during any prior test iteration including during the first test iteration. The first iteration can be an initial iteration.

Each of the one or more sensors can be arranged at or adjacent to the one of the one or more actuators so as to be arranged in between one of the one or more actuators and the item when the item is installed to the test device. At least one of the one or more sensors may include a load cell.

At least one of the one or more actuators can be a hydraulic actuator.

The actual sensor-detectable condition can be selected from the group that may include load, velocity, acceleration, pressure, displacement, temperature, position, angle, electrical resistivity, and rotations per minute (rpm).

The present summary is provided only by way of example, and not limitation. Other aspects of the present invention will be appreciated in view of the entirety of the present disclosure, including the entire text, claims, and accompanying figures.

### BRIEF DESCRIPTION OF THE DRAWINGS

FIG. 1 is a schematic illustration of an embodiment of a test device and an item to be tested.

FIG. 2 is a flow chart of an embodiment of a profile optimization method.

FIG. 3 is a graph of test signals.

While the above-identified figures set forth one or more embodiments of the present invention, other embodiments are also contemplated as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps, and/or components not specifically shown in the drawings.

### DETAILED DESCRIPTION OF ILLUSTRATIVE EMBODIMENTS

In general, disclosed embodiments of the present invention provide a system and method that allows for testing procedures to be performed using a test device with one or more actuators according to a test profile having multiple segments or rows specifying actuator output transitions to converge upon relative optimum segment lengths and/or overall profile length without the occurrence of dynamic null pacing in some or any segments. Feedback about actual transition times for segments in which null pacing can be analyzed, then the length(s) (that is, segment transition times) of any or all segment(s) in which dynamic null pacing previously occurred can be set to a final value that avoids dynamic null pacing. A relatively optimized final profile can then be established. One or more subsequent testing iterations can be performed using the final profile. Embodiments of the disclosed system and method allow for more efficient profile optimization by helping to reduce the total number of iterations needed for a profile to converge on relatively optimal segment lengths and the overall amount of testing time needed to do so. These and other features and benefits of the present invention will be recognized by persons of ordinary skill in the art in view of the entirety of the present disclosure, including the accompanying drawings.

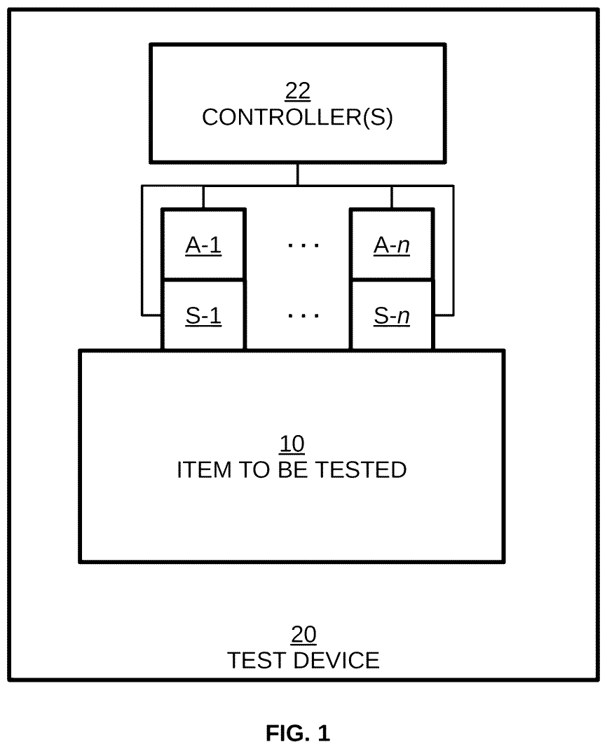

FIG. 1 is a schematic illustration of an item to be tested 10 installed in or otherwise operatively engaged with an embodiment of a test device 20. In the illustrated embodiment, the test device (or test machine) 20 includes one or more controller(s) 22, one or more actuator(s) A-1 to A-n and one or more sensor(s) S-1 to S-n. The embodiment of the test device 20 shown in FIG. 1 is highly schematic. Moreover, the illustrated embodiment of the test device 20 is shown merely by way of example and not limitation. Numerous other embodiments are possible and contemplated. Implementations of the test device 20 can vary from the configuration illustrated in FIG. 1 in further embodiments. Moreover, embodiments of the test device 20 can include features or components not specifically shown in FIG. 1, such as a fixture for holding the item to be tested 10 for testing, one or more frame(s) for holding the actuator(s) A-1 to A-n, additional sensors, network communication hardware, networked user workstation computer(s), user interface devices, etc.

As shown in FIG. 1, the actuator(s) A-1 to A-n are arranged to selectively change a sensor-detectable condition of the item to be tested 10 and the sensor(s) S-1 to S-n are configured to sense data associated with testing using the test device 20. The actuator(s) A-1 to A-n can be load-applying actuator(s) (such as hydraulic or pneumatic actuators, solenoid actuators, etc.), pressure regulator(s), position adjusting actuators, or any other suitable type of actuator, and can be of the same or different types in various embodiments. The number of actuator(s) A-1 to A-n and the particular arrangement of the actuator(s) A-1 to A-n can vary as desired for a given test, based, for instance, on the nature of the item to be test 10, the type of testing desired, etc. In some embodiments, a plurality (two or more) of the actuator(s) A-1 to A-n are present. The configuration of the sensor(s) S-1 to S-n can vary depending on the type of testing desired. For example, the sensor(s) S-1 to S-n can be configured to sense, directly or indirectly, actual conditions of loading, velocity, acceleration, pressure, displacement, position, angle, rotations per minute (RPM), temperature, electrical resistivity, or other sensor-measurable physical conditions associated with the item to be tested 10. The number and arrangement of the sensor(s) S-1 to S-n can also vary as desired for particular applications. In the illustrated embodiment, there are the same number of the sensor(s) S-1 to S-n as the actuator(s) A-1 to A-n, and each one of the sensor(s) S-1 to S-n is located at or adjacent to one of the actuator(s) A-1 to A-n, such that the sensor(s) S-1 to S-n can be arranged in between one of the actuator(s) A-1 to A-n and the item to be tested 10 when the item to be tested 10 is installed to the test device. Alternatively, the sensor(s) S-1 to S-n can be integrated into the actuator(s) A-1 to A-n in some embodiments.

Each of the actuator(s) A-1 to A-n and the sensor(s) S-1 to S-n are connected to one or more of the controller(s) 22. The controller(s) 22 include one or more computer processors, machine-readable memory, and or other suitable hardware. The controller(s) 22 can, individually or collectively, execute machine-readable instructions (e.g., software or firmware) stored in a non-transitory storage medium (e.g., the machine-readable memory) to control testing using the test device 20, including, for example, commanding operation of the actuator(s) A-1 to A-n and/or gathering data with the sensor(s) S-1 to S-n. The controller(s) 22 are further able to interact with one or more users through user interface(s), perform calculations and analyses of collected data, execute testing protocols, generate outputs, communicate with external devices, etc.

During operation of the test device 20, the sensor(s) S-1 to S-n can provide feedback to the controller(s) regarding actual loading by the actuator(s) A-1 to A-n. Feedback from the sensor(s) S-1 to S-n can be in the form of force, pressure, displacement, velocity, or any other desired characteristic suitable for a given test. For example, in some embodiments, the sensor(s) S-1 to S-n can be load cells, which can be arranged in a load transmission path between the actuator(s) A-1 to A-n and the item to be tested. Additional sensors (not shown) such as strain gauges, position sensors, etc. can optionally be arranged to operationally sense or measure parameters (e.g., strain, position, pressure, etc.) related to the item under test.

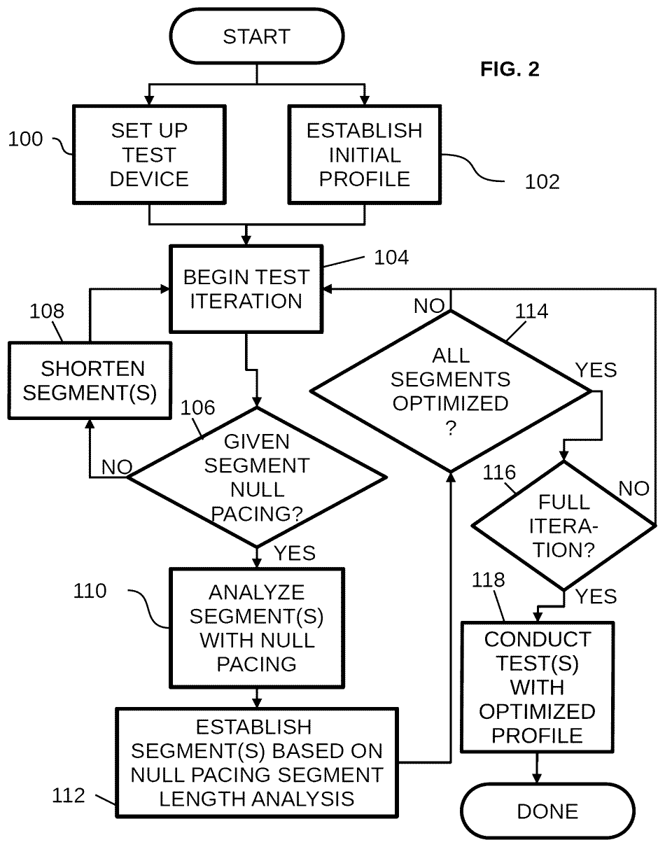

FIG. 2 is a flow chart of an embodiment of a profile optimization method. The illustrated method is shown merely by way of example and not limitation.

Initially, the test device 20 is set up (Step 100). This initial set up step can include physical set-up actions such as installing the item to be tested 10 in the test device 20, arranging and configuring the actuator(s) A-1 to A-n and the sensor(s) S-1 to S-n, etc. The manner in which the test device 20 is set up is determined by the user, in light of the particular type of testing desired (e.g., fatigue or durability testing, etc.) and particular characteristics of the item to be tested 10.

Additionally, an initial profile is established (Step 102). The establishment of the initial profile and the test device set up (Steps 100 and 102) can occur in any order, including simultaneously. A given profile for use with the test device 20 can include information specifying how the actuator(s) A-1 to A-n should change sensor-detectable conditions of the over time (e.g., how to apply load(s) to the item to be tested 10 over time). A profile can, for instance, be expressed in the form of a table with rows denoting a channel that indicates actuator output conditions over time for one or more of the actuator(s) A-1 to A-n that are commonly commanded to change specified sensor-detectable conditions of the item to be tested 10. The time between any two adjacent actuator output conditions in a profile is referred to as a segment. Each segment can encompass one or more discrete channels, each controlling one or more of the actuator(s) A-1 to A-n. In this sense, individual actuator(s) A-1 to A-n and/or groups of multiple ones of the actuator(s) A-1 to A-n can make up a given channel, which can be represented as a row in a table that is part of the profile.

Establishing an initial profile can include setting initial segment transition times (that is, segment lengths) for each desired segment for each channel, setting transition wave shape (e.g., sinusoidal), enabling profile self-optimization (at the segment and/or entire test level), and setting profile convergence values. A user can enter profile convergence values that can be subsequently utilized by the controller(s) to automatically optimize the profile to create a new iteration of the profile based on feedback from a prior test iteration. As examples, profile convergence values can include a maximum step, a threshold, and a minimum time. The maximum step value sets a magnitude of the largest change that the test device 20 can automatically make to adjust segment lengths (segment transition times) from an immediately prior iteration of the profile. The threshold sets a magnitude of the smallest change that the test device 20 can automatically make to adjust segment lengths (segment transition times) from an immediately prior iteration of the profile, such that if analysis of an automatic self-optimization by the test device 20 determines that a change to a given segment length would be less than the user-specified threshold value, no change is made to that segment for the next iteration of the profile (that is, threshold establishes a kind of dead zone to avoid unwanted small changes). The maximum step and threshold values can each be specified as percentages of a reference time (e.g., the segment transition time/length). For example, the maximum step can be 10% and the threshold can be 1%, although users can specify essentially any desired percentage values (although the maximum step must be greater than zero). In some embodiments, a maximum step that is higher, such as 20% or more, may help promote faster profile optimization convergence. The minimum time can set an absolute minimum segment transition time (shortest segment length) that the test device 20 can act upon. Automatic self-optimization can be omitted and not performed for a segment with a transition time (length) that is less than the user-specified minimum time. The minimum time can be set as an absolute period of time, such as 0.10 seconds.

After the test device is set up (Step 100) and the initial profile is established (Step 102), a test iteration is initiated using the test device 20 (Step 104). Initiation of testing begins by using the applicable profile (e.g., the initial profile for the initial iteration), and involves changing sensor-detectable conditions of the item to be tested 10 (e.g., by applying loads) using the actuator(s) A-1 to A-n and sensing data using the sensor(s) S-1 to S-n, governed by the controller(s) 22 and the profile. The actuator(s) A-1 to A-n are commanded to actuate to affect physical conditions of the item to be tested 10 according to the profile used for each corresponding test iteration, although actual sensor-detectable changes applied to the item to be tested 10 may deviate from the expected or desired sensor-detectable changes, such as if dynamic null pacing occurs in one or more segments for one or more channels. For example, a given profile segment may specify a sinusoidal load transition (as a segment transition) but actual loading, due to null pacing, may result in at least one relatively “flat” rather than sinusoidal portion of a load transition. Actual sensor-detectable conditions of the item to be tested 10 measured by the sensor(s) S-1 to S-n are physical characteristics such as the actual sensor-detectable condition is selected from the group consisting of load, velocity, acceleration, pressure, displacement, temperature, position, angle, electrical resistivity, or rotations per minute (RPM).

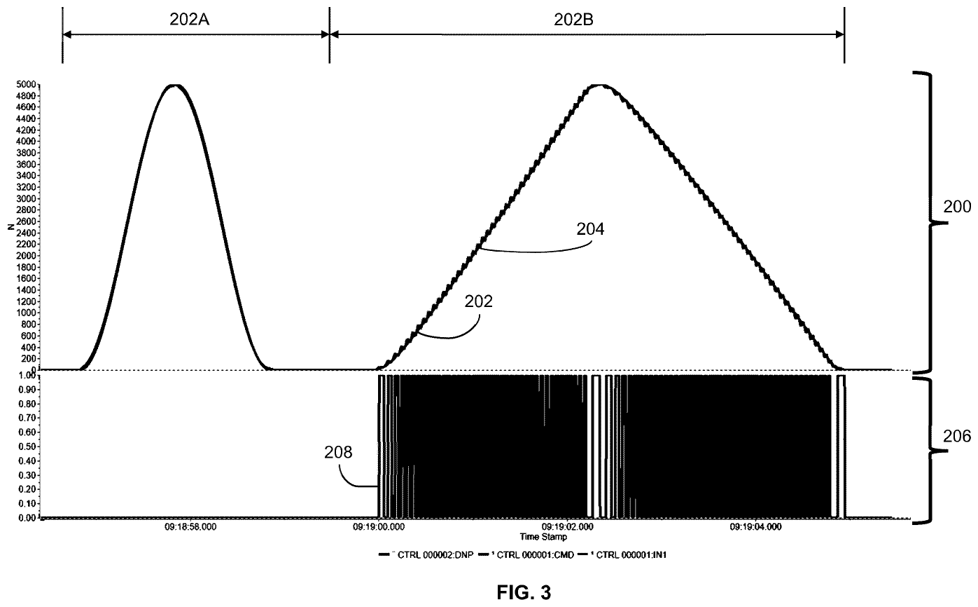

FIG. 3 is a graph of test signals representing an example test iteration. As shown in FIG. 3, there is a first plot 200 (at the top of the graph) showing a command signal 202 for a given actuator channel as well as a sensor feedback signal 204, plus a second plot 206 showing a dynamic null pacing bit 208. Both the first and second plots 200 and 206 are plotted against time on a common horizontal axis. As illustrated, the command signal 202 provides a number of segments 202A and 202B (indicated only generally and not precisely in the drawing), which are plotted against load in the vertical axis, with each segment 202A and 202B designating a segment transition (in this case, a load transition) having a sinusoidal shape that represents desired actuation by one or more of the actuator(s) A-1 to A-n in the given channel. The sensor feedback signal 204 represents an actual sensor-detectable condition, as sensed by one or more of the sensor(s) S-1 to S-n. The dynamic null pacing bit 208 has a value of either zero (0), indicating that dynamic null pacing is not occurring at the corresponding time, or one (1), indicating that dynamic null pacing is occurring at the corresponding time. In the illustrated graph, during the segment 202A, the command signal 202 and the sensor feedback signal 204 stay within an acceptable margin of each other, represented by both plot curves have substantially the same sinusoidal shape with little to no separation, and dynamic null pacing does not occur, represented by the dynamic null pacing bit 208 remaining at zero throughout. In the segment 202B, the sensor feedback signal 204 departs from the command signal 202 significantly and dynamic null pacing is activated, resulting in the sensor feedback signal 204 having essentially horizontal portions or a stepped appearance rather than the sinusoidal appearance of the command signal 202, and resulting in the dynamic null pacing bit 208 changing to a one value for each of multiple time periods during which dynamic null pacing was active to alter actuation of the actuator(s) A-1 to A-n in the given channel.

After the test iteration has been initiated, such as after completion of the given test iteration, the test device 20, such as using the controller(s) 22, can evaluate if dynamic null pacing has occurred for each segment and channel (Step 106), and can also identify any and all such segments by channel. Null pacing may or may not occur in any given test iteration, at all or for any given profile segment for a given channel. Whether or not null pacing occurs depends on, for instance, the nature of the item to be tested 10, the setup of the test device 20, performance characteristics (including possible wear or faults) of the actuator(s) A-1 to A-n, user-specified contents of the initial profile, as well as any automatic adjustments to the profile made by the test device 20 in view of one or more prior test iterations (for any subsequent test iterations). Step 106 can perform a segment-by-segment determination as to whether null pacing has occurred in the current test iteration, or previously occurred in a prior test iteration (if any). For any channel that encompasses multiple actuator(s) A-1 to A-n, null pacing is determined to occur on that channel even if null pacing was only caused by less than all of the actuator(s) A-1 to A-n of that channel during the given segment.

In a typical test device, such as one using MTS AeroPro™ software available from MTS Systems Corporation (Eden Prairie, MN, USA), if a difference between an actual and commanded sensor-detectable change of a given channel in a given profile segment is too great (that is, outside a specified allowable error margin), the test device 20 can automatically slow the rate of change of actuator actuation of that segment by applying dynamic null pacing as part of a proportional integral derivative (PID) control loop mechanism implemented by the controller(s) 22. In this way, dynamic null pacing can interrupt test progress for a given channel in a given segment to help ensure valid and/or reliable test data is collected.

If no null pacing occurs (or has not previously occurred) in given segment(s) upon evaluation at Step 106, then the profile (from the immediately prior test iteration i) can be adjusted automatically by the test device 20 to shorten (that is, reduce the segment transition time of) some or all of the segments of that profile that did not experience null pacing as part of creating a different iteration (e.g., iteration i+1) of the profile (Step 108). These shortening adjustments to segment lengths can occur concurrently or in parallel for all or any number of channels and segments of a given profile, in some embodiments. The adjustments at Step 108 can be made according to the user-specified profile convergence values. More rapid convergence to optimal segment lengths may be promoted by specifying relatively significant maximum steps, in some embodiments. However, if a given segment was previously optimized to an optimized value based on a prior test iteration, then no further shortening occurs at Step 108, and, if the segment lengths have reached the user-specified minimum time, then no further shortening occurs at Step 108. Then the method returns to Step 104 to begin another test iteration utilizing the latest profile iteration resulting from Step 108 (after any steps relating to segments in which null pacing occurred in the current iteration have also been performed). In this way, Steps 104, 106, and 108 allow a portion of the overall method to involve an iterative guess-and-check approach to profile segment shortening to reach a profile iteration in which dynamic null pacing occurs for each segment (by channel) during at least one test iteration, thus ensuring that all segments are no longer than needed, accounting for the user-specified minimum time, to help reduce the overall time required to complete a test iteration. Any segment(s) that have not yet experienced null pacing can continue to be shortened in subsequent test iterations until null pacing occurs in those segment(s), leaving any other segment(s) that have previously experienced null pacing (and have previously been adjusted to an optimized value, as explained further below) or reached the user-specified minimum time without further shortening.

If dynamic null pacing occurs in at least one segment for at least one channel in a given test and profile iteration as determined at Step 106, then the test device 20 can analyze some or all segment(s) with null pacing to evaluate the actual time needed for segment transition for each such segment subject to null pacing, by channel (Step 110). This analysis for each such segment can be performed utilizing data from the sensor(s) S-1 to S-n, such as from the one or more sensor(s) S-1 to S-n associated with the one or more actuator(s) A-1 to A-n in the given channel governed by the given segment of the profile in which null pacing occurred, as well as using time data available from a processor and/or clock module of the controller(s) 22 that is correlated with that data. In some embodiments, a Profile Analyzer module in MTS AeroPro™ software can be utilized to measure the actual time to complete segment transitions in segments in which null pacing occurred.

After the null pacing segment analysis at Step 110, the profile (from the immediately prior test iteration) can be adjusted automatically by the test device 20 to lengthen (that is, increase the segment transition time of) some or all of the segments of that profile that have experienced null pacing to create an optimized iteration of a given segment based on the dynamic null pacing segment analysis (Step 112). The adjustments made to segment lengths for the optimized segment iteration can be set to be equal, or approximately equal, to the actual segment transition times for that segment in which null pacing occurred in the prior iteration as measured during the analysis at Step 110. For example, if the analysis at Step 110 shows that a given segment actually took 4 seconds to complete as a result of null pacing, the optimized segment length in the adjusted profile can be set to 4 seconds. These adjustments to increase segment lengths in a profile can occur concurrently or in parallel for all channels and segments of the given profile in which null pacing occurred, in some embodiments. The adjustments at Step 112 can be made according to the user-specified profile convergence threshold value; however, any user-specified minimum time value will be irrelevant to the lengthening of segments and any user-specified maximum step value can be ignored for Step 112 or not collected/specified at all, at least in some embodiments.

It is possible for lengths of different segments to be both shortened and lengthened concurrently. Therefore, in at least some embodiments, following Step 112, the test device 20 can determine whether or not all segments in the profile have experienced null pacing in any test iteration (e.g., in Step 104), whether that null pacing occurred in the current test iteration or a prior test iteration, to determine if all segments have been optimized (Step 114). If not, then the method can return to Step 104 to perform another test iteration (after Step 108 has also been completed for any other segments that are being iteratively shortened). When all segments have null paced and been adjusted to an optimized length, then the overall profile can be finalized in a relative optimum state (or alternatively the optimization process can continue essentially indefinitely, to account for physical changes to the item being tested, such as metal fatigue, etc.). In this way, for any segment (by channel) in which null pacing has occurred in the current test iteration, a final segment length for such segments can be established in essentially one step, even if further iterations of the overall profile are needed to optimize other segments. But eventually the profile converges on a final iteration or final profile and no further iterations are needed for profile optimization.

After all segments have, individually null paced at least once, a determination can be made if a full or complete test iteration has been performed without any null pacing on any segment (Step 116). If not, the method can return to Step 104 to perform another test iteration. If so, the method can proceed to Step 118.

Lastly, after all individual segments in the profile have been optimized, and a complete test iteration is run with no null pacing in any segments, an optimized overall profile can be established and one or more testing iterations are conducted using the optimized profile (Step 118). In this way, profile optimization to avoid null pacing in a given segment can be performed with as little as one adjustment to the last iteration of the segment profile in which null pacing occurred. This means that while an iterative guess-and-check approach can still be used to shorten profile segments (until null pacing occurs) for profile optimization, an optimized segment optimization that lengthens at least one segment and establishes an optimized length of those lengthened segment(s) (to try to avoid null pacing in future iterations) can occur in fewer iterations or adjustments, such as in a single iteration or adjustment, without requiring the often lengthy multiple-iteration guess-and-check approach for segment lengthening. This allows the length of any given segment to converge to an optimized iteration with as little as a single adjustment following the occurrence of null pacing in that segment. Continued testing can then involve using a fixed of static optimized profile, or can indefinitely continue optimization as described above, which can help account for changes in the physical characteristics of the item to be tested over time (e.g., metal fatigue), degradation, failure, or other changes in the performance of an actuator, etc.

Embodiments of the present invention allow a test device to automatically converge a profile to a relative optimum relatively quickly and to reduce the use of iterative guess-and-check optimization that can require a significant number of iterations and time, and to promote stability of optimization convergence. Numerous other features and benefits will be appreciated by persons of ordinary skill in the art in view of the entirety of the present disclosure.

### Discussion of Possible Embodiments

A method of optimizing a test profile for testing an item to be tested can include: performing a test iteration by changing a sensor-detectable condition of the item to be tested using one or more actuators according to an iteration of the test profile; measuring an actual sensor-detectable condition during the test iteration; identifying a first segment of the test profile specifying a first segment transition for a channel encompassing one or more of the one or more actuators in which dynamic null pacing occurred when executing the first segment during the test iteration; measuring a first duration during the test iteration, in which the first duration is an actual length of a segment transition for the channel during the test iteration corresponding to a specified segment transition of the first segment; increasing a length of the first segment to be equal to the first duration in a first adjusted iteration of the test profile; and performing another test iteration by changing the sensor-detectable condition of the item to be tested using the one or more actuators according to the first adjusted iteration of the test profile.

The method of the preceding paragraph can optionally include, additionally and/or alternatively, any one or more of the following features, configurations, and/or additional steps:
identifying a second segment of the test profile specifying a second segment transition for at least one of the one or more actuators in which dynamic null pacing did not occur when executing the second segment during the test iteration, and decreasing a length of the second segment;
the step of identifying the second segment in which dynamic null pacing did not occur can be performed concurrently with the step of identifying the first segment of the test profile in which dynamic null pacing occurred, or, alternatively, at non-concurrent times;
performing a prior test iteration by changing the sensor-detectable condition of the item to be tested using the one or more actuators according to a prior iteration of the test profile, in which the test iteration occurs after the prior test iteration (that is, the prior test iteration occurs before the test iteration), determining that dynamic null pacing did not occur when executing the first segment during the prior test iteration, and decreasing a length of the first segment, such that the length of the first segment in the iteration of the test profile is shorter than the length of the first segment in the prior iteration of the test profile;
the step of measuring the actual sensor-detectable condition during the test iteration can involve sensing loading in a load path between at least one of the one or more actuators and the item to be tested;
the test profile can be further adjusted as the item to be tested undergoes physical changes over a plurality of test iterations; and/or
the actual sensor-detectable condition can be load, velocity, acceleration, pressure, displacement, temperature, electrical resistivity, position, angle, or rotations per minute (RPM).

A method of testing an item with a test device can include: establishing an initial iteration of a test profile with a plurality of segments each specifying a load transition; performing an initial test iteration by applying loads to the item using a plurality of actuators according to the initial iteration of the test profile; measuring actual loading during the initial test iteration; identifying dynamic null pacing during at least the initial test iteration; measuring a first duration, in which the first duration is an actual length of a load transition during the initial test iteration corresponding to a specified load transition of the initial iteration of the test profile; iteratively shortening a length of at least one of the segments of the test profile in which null pacing has not yet occurred during any prior test iteration including during the initial test iteration; increasing a length of the least one of the segments of the test profile based on analysis of the identified dynamic null pacing such that the length of the least one segment of the test profile is equal to the first duration in an adjusted iteration of the test profile; and performing another test iteration by applying loads to the item using the plurality of actuators according to the adjusted iteration of the test profile.

The method of the preceding paragraph can optionally include, additionally and/or alternatively, any one or more of the following features, configurations, and/or additional steps:
the step of increasing the length of the at least one segment of the test profile based on analysis of the identified dynamic null pacing can increase the length of at least one of the segments that was previously shortened during the step of iteratively shortening the length of at least one of the segments of the test profile in which null pacing has not yet occurred during any prior test iteration including during the initial test iteration;
the step of increasing the length of at least one segment of the test profile based on analysis of the identified dynamic null pacing can be performed concurrently with the step of iteratively shortening the length of at least one of the segments of the test profile in which null pacing has not yet occurred during any prior test iteration including during the initial test iteration; and/or
the step of measuring actual loading during the initial test iteration can involve sensing loading in a load path between the plurality of actuators and the item.

A test device for testing an item can include: one or more actuators; one or more sensors; one or more controllers operatively connected to the one or more actuators and the one or more sensors; and machine-readable instructions stored in at least one non-transitory storage medium. The machine-readable instructions are executable by any number of the one or more controllers to execute the steps of: performing a first test iteration by changing a sensor-detectable condition of the item using the one or more actuators according to a first iteration of a test profile; measuring an actual sensor-detectable condition during the first test iteration using the one or more sensors; identifying dynamic null pacing during at least the first test iteration using at least one of the one or more controllers; measuring a first duration, in which the first duration is an actual length of a segment transition during the first test iteration corresponding to a specified sensor-detectable condition transition of the first iteration of the test profile; and increasing a length of at least one segment of the test profile based on analysis of the identified dynamic null pacing such that the length of the least one segment of the test profile is equal to the first duration in an adjusted iteration of the test profile.

The test device of the preceding paragraph can optionally include, additionally and/or alternatively, any one or more of the following features, configurations, and/or additional components:
the machine-readable instructions can be further configured to execute the step of iteratively shortening a length of at least one of the segments of the test profile in which null pacing has not yet occurred during any prior test iteration including during the first test iteration;
the first iteration can be an initial iteration;
each (or, alternatively, at least one) of the one or more sensors can be arranged at or adjacent to the one of the one or more actuators so as to be arranged in between one of the one or more actuators and the item when the item is installed to the test device;
at least one of the one or more sensors can comprise a load cell;
at least one of the one or more actuators can be a hydraulic actuator; and/or
the actual sensor-detectable condition can be load, velocity, acceleration, pressure, displacement, temperature, position, angle, electrical resistivity, or rotations per minute (RPM), for example.

### Summation

Any relative terms or terms of degree used herein, such as “substantially”, “essentially”, “generally”, “approximately”, and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, transitory signal fluctuations due to noise, measurement imprecision (and/or limits on measurement precision), and the like. Moreover, any relative terms or terms of degree used herein should be interpreted to encompass a range that expressly includes the designated quality, characteristic, parameter, or value, without variation, as if no qualifying relative term or term of degree were utilized in the given disclosure or recitation.

The word “comprise”, or variations such as “comprises” or “comprising” are used in an open-ended manner herein and should be interpreted to refer to the inclusion of a stated element, feature, or step, or group of elements, features, or steps, but not the exclusion of any other element, feature, or step, or group of elements, features, or steps. Unless further expressly qualified, use of the word “comprise” or variations thereof does not, alone, exclude the present additional, unrecited elements, steps, or groups of elements or steps. Additionally, unless further expressly qualified, the words “a” and “an” as used herein refer to one or more and do not limit the identified element, feature, step, or the like to one and only one. However, use of the words “a” and “an” herein should be interpreted in accordance with and subject to any applicable further limits expressly stated in the context of any particular instance of usage, without extending such context-specific limits to all other uses generally.

Although the present invention has been described with reference to preferred embodiments, workers skilled in the art will recognize that changes may be made in form and detail without departing from the spirit and scope of the invention.

1. A method of optimizing a test profile for testing an item to be tested, the method comprising:
performing a test iteration by changing a sensor-detectable condition of the item to be tested using one or more actuators according to an iteration of the test profile;
measuring an actual sensor-detectable condition during the test iteration;
identifying a first segment of the test profile specifying a first segment transition for a channel encompassing one or more of the one or more actuators in which dynamic null pacing occurred when executing the first segment during the test iteration;
measuring a first duration during the test iteration, wherein the first duration is an actual length of a segment transition for the channel during the test iteration corresponding to a specified segment transition of the first segment;
increasing a length of the first segment to be equal to the first duration in a first adjusted iteration of the test profile; and
performing another test iteration by changing the sensor-detectable condition of the item to be tested using the one or more actuators according to the first adjusted iteration of the test profile.

2. The method of claim 1 and further comprising:
identifying a second segment of the test profile specifying a second segment transition for at least one of the one or more actuators in which dynamic null pacing did not occur when executing the second segment during the test iteration; and
decreasing a length of the second segment.

3. The method of claim 2, wherein the step of identifying the second segment in which dynamic null pacing did not occur is performed concurrently with the step of identifying the first segment of the test profile in which dynamic null pacing occurred.

4. The method of claim 1 and further comprising:
performing a prior test iteration by changing the sensor-detectable condition of the item to be tested using the one or more actuators according to a prior iteration of the test profile, wherein the test iteration occurs after the prior test iteration;
determining that dynamic null pacing did not occur when executing the first segment during the prior test iteration; and
decreasing a length of the first segment, such that the length of the first segment in the iteration of the test profile is shorter than the length of the first segment in the prior iteration of the test profile.

5. The method of claim 1, wherein the step of measuring the actual sensor-detectable condition during the test iteration involves sensing loading in a load path between at least one of the one or more actuators and the item to be tested.

6. The method of claim 1, wherein the test profile is further adjusted as the item to be tested undergoes physical changes over a plurality of test iterations.

7. The method of claim 1, wherein the actual sensor-detectable condition is selected from the group consisting of load, velocity, acceleration, pressure, displacement, temperature, electrical resistivity, position, angle, and rotations per minute (RPM).

8. A method of testing an item with a test device, the method comprising:
establishing an initial iteration of a test profile with a plurality of segments each specifying a load transition;
performing an initial test iteration by applying loads to the item using a plurality of actuators according to the initial iteration of the test profile;
measuring actual loading during the initial test iteration;
identifying dynamic null pacing during at least the initial test iteration;
measuring a first duration, wherein the first duration is an actual length of a load transition during the initial test iteration corresponding to a specified load transition of the initial iteration of the test profile;
iteratively shortening a length of at least one of the segments of the test profile in which null pacing has not yet occurred during any prior test iteration including during the initial test iteration;
increasing a length of the at least one of the segments of the test profile based on analysis of the identified dynamic null pacing such that the length of the at least one of the segments of the test profile is equal to the first duration in an adjusted iteration of the test profile; and
performing another test iteration by applying loads to the item using the plurality of actuators according to the adjusted iteration of the test profile.

9. The method of claim 8, wherein the step of increasing the length of the at least one of the segments of the test profile based on analysis of the identified dynamic null pacing increases the length of the at least one of the segments that was previously shortened during the step of iteratively shortening the length of the at least one of the segments of the test profile in which null pacing has not yet occurred during any prior test iteration including during the initial test iteration.

10. The method of claim 8, wherein the step of increasing the length of the at least one of the segments of the test profile based on analysis of the identified dynamic null pacing is performed concurrently with the step of iteratively shortening the length of at the least one of the segments of the test profile in which null pacing has not yet occurred during any prior test iteration including during the initial test iteration.

11. The method of claim 8, wherein the step of measuring actual loading during the initial test iteration involves sensing loading in a load path between the plurality of actuators and the item.

12. A test device for testing an item, the test device comprising:
one or more actuators;
one or more sensors;
one or more controllers operatively connected to the one or more actuators and the one or more sensors; and
machine-readable instructions stored in at least one non-transitory storage medium and executable by any number of the one or more controllers to execute the steps of:
performing a first test iteration by changing a sensor-detectable condition of the item using the one or more actuators according to a first iteration of a test profile;
measuring an actual sensor-detectable condition during the first test iteration using the one or more sensors;
identifying dynamic null pacing during at least the first test iteration using at least one of the one or more controllers;
measuring a first duration, wherein the first duration is an actual length of a segment transition during the first test iteration corresponding to a specified sensor-detectable condition transition of the first iteration of the test profile; and
increasing a length of at least one segment of the test profile based on analysis of the identified dynamic null pacing such that the length of the at least one segment of the test profile is equal to the first duration in an adjusted iteration of the test profile.

13. The test device of claim 12, wherein the machine-readable instructions are further configured to execute the step of:
iteratively shortening a length of at least one segment of the test profile in which null pacing has not yet occurred during any prior test iteration including during the first test iteration.

14. The test device of claim 12, wherein the first iteration is an initial iteration.

15. The test device of claim 12, wherein each of the one or more sensors is arranged at or adjacent to the one of the one or more actuators so as to be arranged in between one of the one or more actuators and the item when the item is installed to the test device.

16. The test device of claim 12, wherein at least one of the one or more sensors comprises a load cell.

17. The test device of claim 12, wherein at least one of the one or more actuators is a hydraulic actuator.

18. The test device of claim 12, wherein the actual sensor-detectable condition is selected from the group consisting of load, velocity, acceleration, pressure, displacement, temperature, position, angle, electrical resistivity, and rotations per minute (RPM).
